(19) United States
(12) Patent Application Publication
(10) Pub. No.: US 2017/0165724 A1
(43) Pub. Date: Jun. 15, 2017

(54) CLEANING INSTALLATION, TRANSFORMATION PROCESS AND CLEANING METHOD IMPLEMENTING SUCH A CLEANING INSTALLATION

(71) Applicant: BOCCARD SERVICES SA, Meyrin (CH)

(72) Inventor: Philippe GUICHOUX, Juriquilla (MX)

(21) Appl. No.: 15/374,839

(22) Filed: Dec. 9, 2016

(30) Foreign Application Priority Data
Dec. 11, 2015 (FR) 15/62182

(51) Int. Cl. B08B 9/08

(52) U.S. Cl. CPC B08B 9/08; B08B 2203/007

(57) ABSTRACT

This cleaning installation (1) comprises:
several storage vessels (2.1, 2.2, 2.3) each configured to store a respective cleaning liquid;
a distribution module (4) having a distribution pipe (6.1, 6.2) for channeling a cleaning liquid to an item of equipment to be cleaned (102), and
several transfer conduits (10.1, 10.2, 10.3) each fluidly connected to a respective storage vessel (2.1, 2.2, 2.3), the distribution module (4) being fluidly connected to several of the transfer conduits (10.1, 10.2, 10.3).

### TECHNICAL FIELD

The present invention concerns a cleaning installation for cleaning equipment to be cleaned in a production plant. Furthermore, the present invention concerns a transformation process intended to improve a conventional cleaning installation.

### BACKGROUND

The present invention may be applied to food, cosmetic, pharmaceutical or biotechnological production plants. In particular, the present invention may be applied to the production of a milk-based food product, such as yogurt.

EP2362008A1 describes a cleaning installation for cleaning containers in a production plant. The cleaning installation of EP2362008A1 comprises several storage vessels configured to respectively store various cleaning liquids. Furthermore, the cleaning installation of EP2362008A1 comprises a single supply line which fluidly connects each storage vessel directly to the equipment to be cleaned, while extending over a long length. In use, all the cleaning liquids circulate in this supply line, which is therefore common to all the storage vessels. During a cleaning method implementing the cleaning installation of EP2362008A1, all the cleaning liquids circulate one after the other towards each item of equipment to be cleaned.

However, the supply line therefore allows only cleaning one item of equipment at once, which extends the cleaning duration of a production plant comprising several items of equipment to be cleaned.

In addition, during a transition phase, a cleaning liquid must [symbol] push [symbol] the preceding cleaning liquid until reaching the concentration necessary for cleaning the item of equipment, which requires emptying into drains the entire mixture of the two cleaning liquids as long as the required concentration is not reached. Each transition phase induces long cleaning durations and high consumption of cleaning liquid.

Moreover, when the preceding cleaning liquid is cold (e.g. basic solution at ambient temperature), the supply line will be cooled to the temperature of the preceding cleaning liquid. Then, when the next cleaning fluid is hot (e.g. water at 90° C.), it must firstly heat the supply line to reach the item of equipment to be cleaned at the required temperature. This reheating of the supply line induces a high energy consumption.

Furthermore, as the supply line directly supplies several items of equipment to be cleaned, the supply line must be sized to be able to supply the cleaning liquids with sufficient flow rates, pressures and volume for the largest item of equipment to be cleaned. Therefore the supply line is oversized for all equipment smaller than the large item of equipment to be cleaned, which induces a high cost for the cleaning installation.

### BRIEF SUMMARY

According to an embodiment, a cleaning installation, for cleaning equipment to be cleaned, for example containers, in a production plant, the cleaning installation comprising several storage vessels each configured to store a respective cleaning liquid;

the cleaning installation being characterized in that it further comprises:
at least one distribution module comprising at least one distribution pipe configured to channel a cleaning liquid towards at least one item of equipment to be cleaned, the at least one distribution module being intended to be arranged near at least one item of equipment to be cleaned, and
several transfer conduits, each transfer conduit being fluidly connected to a respective storage vessel, the at least one distribution module being fluidly connected to several of the transfer conduits.

In other words, the cleaning liquids circulate in separate transfer conduits. Thus, each transfer conduit supplies several items of equipment to be cleaned with a single cleaning liquid. Therefore, such a cleaning installation allows reducing the cleaning durations and the cleaning liquid consumptions.

Each transition phase, where a cleaning liquid pushes and discharges the preceding cleaning liquid, requires a very short duration and a very small cleaning liquid volume. Indeed, the common section where several cleaning liquids successively circulate is much shorter than the supply line of a conventional cleaning installation, since this common section is limited to one or each distribution module.

Furthermore, this allows reducing the energy consumption, because each transfer conduit remains at the temperature of the cleaning liquid that it transfers.

According to a variant, at least one of the transfer conduits is rigid. The at least one rigid transfer conduit may be composed of a tubing. According to a variant, several of the transfer conduits are rigid. For example, all the transfer conduits may be rigid.

Alternatively to this variant, at least one of the transfer conduits is flexible. According to a variant, several of the transfer conduits are flexible. For example, all the transfer conduits may be flexible.

The cleaning liquids may be selected in particular from detergent solutions, such as more or less warm water (70° C., 90° C. etc.), cold water or at ambient temperature (20° C.), acid solutions, basic solutions.

The number of storage vessels is determined by the number of detergent solutions recommended for cleaning the equipment, generally depending on the technical field (food, cosmetic, pharmaceutical or biotechnological). A cleaning liquid may comprise solid particles, which forms a viscous mixture (sometimes called by the English term [symbol] slurry [symbol] ).

According to a variant, the cleaning installation comprises at least three storage vessels, for example six storage vessels. The storage vessels may store respectively water at ambient temperature, water at 70° C., water at 90° C., an acid detergent solution and a basic detergent solution.

In the present application, the term [symbol] item of equipment [symbol] means any component of a production plant which is in contact with the manufactured product and which may be cleaned on-site. For example, the equipment may include containers, heat exchangers, packaging machines, and/or transformation machines (example: grinding a powder or incorporating a powder into a cleaning liquid).

According to a variant, at least one storage vessel has a capacity greater than 40 L, for example greater than 100 L. For example, several storage vessels may have capacities greater than 500 L.

According to one embodiment, at least one transfer conduit extends from a respective storage vessel to said at least one distribution module.

According to a variant of this embodiment, several transfer conduits extend from respective storage vessels to said at least one distribution module.

When the cleaning installation comprises several distribution modules, several transfer conduits may extend from respective storage vessels to respective distribution modules.

Alternatively to this variant, a storage vessel and a distribution module may be fluidly connected not only by a transfer conduit but also by other intermediate components.

According to a variant, at least one transfer conduit has a length greater than 20 meters. According to a variant, several transfer conduits have a length greater than 20 meters. In particular, all the transfer conduits may have a length greater than 20 meters.

According to a variant, a distance between the at least one distribution module and each of the storage vessels is greater than 20 meters.

According to a variant, when the cleaning installation is in use, a ratio:
i) of the distance between the distribution module and an item of equipment to be cleaned, that is to say the fluidic length of a distribution pipe,
ii) to the distance between the distribution module and a storage vessel is lower than 10%.

Distance means here a distance traveled by the cleaning liquid circulating between two elements, sometimes called [symbol] fluidic distance [symbol] , and not a distance measured in a straight line between these two elements.

According to one embodiment, the at least one distribution module comprises a heating module including:
a tray configured to contain a cleaning liquid,
a heating member fluidly connected to the tray,
a distribution pump connected to the tray and to the heating member so as to circulate a cleaning liquid from the tray to the heating member.

Thus, such a heating module allows quickly heating the item of equipment to be cleaned, by means of the heated cleaning liquid, to the prescribed temperature in order to perform the cleaning of the item of equipment. Indeed, the thermal energy is provided to the distribution module, therefore as close as possible to the item of equipment to be cleaned.

Moreover, each transfer conduit may be sized without taking into account the largest item of equipment to be cleaned, because the tray of the distribution module fulfills the function of a buffer tank storing a small quantity of liquid just upstream of the equipment to be cleaned. Because of this buffer tank, the supply line allows simultaneously cleaning several items of equipment, which reduces the cleaning duration of a production plant comprising several items of equipment to be cleaned.

In the present application, the terms [symbol] upstream [symbol] and [symbol] downstream [symbol] refer to the flow direction of the cleaning liquid in the different conduits and pipes when the cleaning installation is in use.

According to a variant of this embodiment, several distribution modules each comprise a tray, such a heating member and such a distribution pump. In particular, each distribution module may comprise a tray, such a heating member and such a distribution pump.

According to one embodiment, the cleaning installation further comprises several transfer pumps arranged such that each storage vessel is fluidly connected to at least one transfer pump, each transfer pump being fluidly connected to at least one transfer conduit.

According to a variant, each storage vessel is fluidly connected to a single transfer pump, and each transfer pump is fluidly connected to a single transfer conduit.

According to a variant, each storage vessel is fluidly connected to a respective single transfer conduit.

According to an embodiment, the at least one distribution module comprises at least:
several transfer pipes, each transfer pipe being fluidly connected to a respective transfer conduit, the transfer pipes being fluidly connected to the distribution pipe,
several transfer valves arranged respectively on the transfer pipes, each transfer valve being configured to be placed at least: i) in a release configuration, in which a cleaning liquid may flow to the at least one distribution pipe, and ii) in a obstruction configuration

According to a variant, several of the distribution modules each comprise such a distribution pipe, such transfer pipes and such transfer valves.

According to an embodiment, at least one of the storage vessels is equipped with at least:
one recirculation loop arranged to fluidly connect two openings of said at least one storage vessel, and
one heating device arranged to heat the cleaning liquid circulating in the recirculation loop.

Thus, such a recirculation loop and such a heating device allow adjusting the temperature of the cleaning liquid stored in such a storage vessel.

In use, the two openings correspond to an inlet and an outlet.

According to a variant, several of the storage vessels are each equipped at least with such a recirculation loop and such a heating device. In particular, all the storage vessels may be each equipped at least with such a recirculation loop and such a heating device.

According to an embodiment, the cleaning installation further comprises at least one loop conduit, said at least one loop conduit fluidly connecting a respective storage vessel to a downstream area of a respective transfer conduit, the downstream area being located near or within the at least one distribution module.

Thus, such loop conduits allow forming an autonomous fluidic network in which a cleaning liquid may permanently circulate upstream of the distribution module. The permanent circulation allows for example stirring a cleaning liquid or to maintain it at a set temperature.

According to a variant, the cleaning installation comprises several loop conduits, each loop conduit fluidly connecting a respective storage vessel to a downstream area of a respective transfer conduit, this downstream area being located near or within a respective distribution module. In particular, loop conduits may be arranged to connect all the storage vessels to respective downstream areas of the transfer conduits.

According to one embodiment, the cleaning installation further comprises several return conduits, each return conduit being fluidly connected to a respective storage vessel, the at least one distribution module being fluidly connected to several of the return conduits.

Thus, such return conduits allow recycling at least partially the cleaning liquid discharged from the equipment to be cleaned. Furthermore, such return conduits allow circulating the liquid to be cleaned so as to make it immediately available at each distribution module.

According to a variant, the transfer conduit is fluidly connected to a lower area of the storage vessel. In particular, each transfer pump may be fluidly connected to a lower area of the storage vessel.

According to a variant, the cleaning installation further comprises inner projection members arranged to project each cleaning liquid onto the inner surfaces of at least one item of equipment to be cleaned. The inner surface of an item of equipment to be cleaned corresponds to all parts which are in contact with the product manufactured in the production plant.

According to a variant, the cleaning installation further comprises outer projection members arranged to project each cleaning liquid onto the outer surfaces of an item of equipment to be cleaned. The outer surface of an item of equipment to be cleaned corresponds to all parts which are not in contact with the product manufactured in the production plant.

According to a variant of the two preceding embodiments, the cleaning installation may further comprise a manual projection member configured to allow an operator to project the cleaning liquids onto the inner surfaces or onto the outer surfaces.

According to a variant, several of the storage vessels are static and assembled so as to form a storage station.

According to a variant of this embodiment, all the storage vessels are static and assembled so as to form a storage station.

Alternatively to this embodiment, several of the storage vessels are movable. According to a variant, all the storage vessels are movable.

According to an embodiment, the cleaning installation further comprises a regulation device, the regulation device including:
physico-chemical sensors each configured to generate signals representative of a respective physico-chemical magnitude,
actuators configured to act on the circulation of the cleaning liquids or on respective physico-chemical magnitudes,
a control unit configured to receive the signals from the physico-chemical sensors and to control the actuators, so as to maintain the physico-chemical magnitudes of the cleaning liquids at predetermined setpoint values.

According to a variant, the physico-chemical magnitudes comprise the electrical conductivity, the temperature and the concentration.

According to a variant, physico-chemical sensors are located in a downstream area of said at least one distribution module. Thus, the physico-chemical sensors measure the physico-chemical parameters as close as possible to the equipment to be cleaned, which ensures that the physico-chemical parameters are at their setpoint values.

According to an embodiment, at least one storage vessel is equipped with:
a main valve intended to be fluidly connected to a water source, and
a secondary valve intended to be fluidly connected to a concentrated solution source,

and the control unit is configured to control the openings and the closures of the main valve and the secondary valve so as to inject the water and/or the concentrated solution into said at least one storage vessel in order to maintain the concentration of the cleaning liquid at a predetermined setpoint value.

According to an embodiment, the control unit is configured to control an automatic cleaning cycle including cleaning phases whose circulation durations and the circulation flow rates of the cleaning liquids are predetermined.

Moreover, a transformation process is provided, for transforming a conventional cleaning installation intended to clean equipment to be cleaned, for example containers, the conventional cleaning installation comprising:
several storage vessels each configured to store a respective cleaning liquid,
a supply line fluidly connected to each storage vessel, the supply line extending over a long length so as to conduct each cleaning liquid to at least one item of equipment to be cleaned;

the transformation process comprising:
adding at least one distribution module comprising at least one pipe configured to channel a cleaning liquid to at least one item of equipment to be cleaned, the at least one distribution module being intended to be arranged near at least one item of equipment to be cleaned, and
replacing the supply line with several transfer conduits, each transfer conduit being fluidly connected to a respective storage vessel, the at least one distribution module being fluidly connected to several of the transfer conduits.

Furthermore, a production plant is provided, for producing at least one food, cosmetic, pharmaceutical or biotechnological product, the production plant comprising equipment to be cleaned, the production plant being characterized in that, it comprises at least one cleaning installation according to the invention, the cleaning installation being configured to clean the equipment to be cleaned.

Moreover, a method for cleaning equipment to be cleaned is provided, for example containers, in a production plant, the cleaning method comprising implementing a cleaning installation according to the invention.

The aforementioned embodiments and variants may be considered separately or according to any technically possible combination.

### BRIEF DESCRIPTION OF THE DRAWINGS

The present invention will be well understood and its advantages will also emerge in the light of the description which follows, given only by way of non-limiting example and made with reference to the appended schematic figures, in which identical reference signs correspond to structurally and/or functionally identical or similar elements. In the appended schematic figures:

FIG. 1 is a schematic view of a cleaning installation in accordance with a first embodiment of the invention;

FIG. 2 illustrates a flow chart illustrating a cleaning method implementing the cleaning installation of FIG. 1;

FIG. 3 is a flow chart illustrating a transformation process in accordance with the invention;

FIG. 4 is a schematic view of a cleaning installation in accordance with a second embodiment of the invention;

FIG. 5 is a schematic view of a cleaning installation in accordance with a third embodiment of the invention; and

FIG. 6 illustrates a flow chart illustrating a cleaning method implementing the cleaning installation of FIG. 5.

### DETAILED DESCRIPTION

FIG. 1 illustrates a production plant 100 comprising equipment to be cleaned 102 and a cleaning installation 1 for cleaning these items of equipment to be cleaned 102. The equipment to be cleaned 102 may, for example, be containers containing food products.

The cleaning installation 1 comprises a plurality of storage vessels 2.1, 2.2 and 2.3. Each storage vessel 2.1, 2.2 or 2.3 is configured to store a respective cleaning liquid. In the example of FIG. 1, each storage vessel 2.1, 2.2 or 2.3 has a capacity equal to about 200 L.

For example, the storage vessel 2.1 contains an acid solution, the storage vessel 2.2 contains hot water at 90° C. and the storage vessel 2.3 contains a basis solution.

Furthermore, the cleaning installation 1 comprises a distribution module 4. The distribution module 4 comprises two distribution pipes 6.1 and 6.2 which are configured to channel a cleaning liquid towards two items of equipment 102 to be cleaned.

When the cleaning installation 1 is in use in the production plant 100, the distribution module 4 is arranged near each item of equipment to be cleaned 102.

The cleaning installation 1 further comprises a plurality of transfer conduits 10.1, 10.2, 10.3. Each transfer conduit 10.1, 10.2 or 10.3 is here fluidly connected to a respective storage vessel 2.1, 2.2 or 2.3. In the example of FIG. 1, the transfer conduits 2.1, 2.2 and 2.3 are rigid and composed each of a tubing.

In this case, each transfer conduit 10.1, 10.2 or 10.3 extends from its respective storage vessel 2.1, 2.2 or 2.3 to the distribution module 4.

Each transfer conduit 10.1, 10.2 or 10.3 has here a length equal to about 20 meters. Therefore, a distance D1 between the distribution module 4 and each of the storage vessels 2.1, 2.2 and 2.3 is here equal to about 20 meters.

When the cleaning installation 1 is in use, a ratio:
i) of the distance D2 between the distribution module 4 and an item of equipment to be cleaned 102, that is to say the fluidic length of the distribution pipes 6.1 and 6.2,
ii) to the distance D1 between the distribution module 4 and a storage vessel 2.3

is here equal to about 5%.

Thus, the transfer conduit 10.1 is fluidly connected to the storage vessel 2.1 and therefore conducts the acid solution; the transfer conduit 10.2 is fluidly connected to the storage vessel 2.2 and therefore conducts the hot water; the transfer conduit 10.3 is fluidly connected to the storage vessel 2.3 and therefore conducts the basic solution.

Therefore the cleaning liquids circulate in transfer conduits 10.1, 10.2 and 10.3 which are distinct. When the cleaning installation 1 is in use, each transfer conduit fluidly supplies several items of equipment to be cleaned 102 with a single cleaning liquid.

The cleaning installation 1 further comprises transfer pumps 18.1, 18.2 and 18.3 which are arranged so that each storage vessel 2.1, 2.2 or 2.3 is fluidly connected to a respective transfer pump 18.1, 18.2 or 18.3. Inversely, each transfer pump 18.1, 18.2 and 18.3 fluidly connected to a transfer conduit 10.1, 10.2 or 10.3.

Each storage vessel 2.1, 2.2 or 2.3 is here fluidly connected to a single transfer pump 18.1, 18.2 or 18.3. Inversely, each transfer pump 18.1, 18.2 and 18.3 is fluidly connected to a single transfer conduit 10.1, 10.2 or 10.3.

The distribution module 4 is fluidly connected to each transfer conduit 10.1, 10.2, 10.3. To this end, the distribution module 4 comprises three transfer pipes 4.1, 4.2 and 4.3.

Each transfer pipe 4.1, 4.2 or 4.3 is fluidly connected to a respective transfer conduit 10.1, 10.2 or 10.3. In the distribution module 4, the transfer pipes 4.1, 4.2 and 4.3 are fluidly connected to the distribution pipes 6.1, 6.2 by a common section 4.6.

Furthermore, the distribution module 4 comprises three transfer valves 4.11, 4.12 and 4.13 which are arranged respectively on the transfer pipes 4.1, 4.2 and 4.3. Each transfer valve 4.11, 4.12 or 4.13 is configured to be placed:
i) in a release configuration, in which cleaning liquid may flow to the distribution pipes 6.1 and 6.2, and
ii) in a obstruction configuration, in which each transfer valve 4.11, 4.12 or 4.13 blocks the circulation of the cleaning liquids in the transfer pipes 4.1, 4.2 and 4.3.

The distribution module 4 also comprises distribution valves 6.11 and 6.21. The distribution valve 6.11 is arranged on the distribution pipe 6.1 so as to selectively allow or prevent the circulation of a cleaning liquid in the distribution pipe 6.1. The distribution valve 6.21 is arranged on the distribution pipe 6.2 so as to selectively allow or prevent the circulation of a cleaning liquid in the distribution pipe 6.2.

The cleaning installation 1 further comprises a regulation device including:
physico-chemical sensors 7 and each configured to generate signals representative of a respective physico-chemical magnitude, actuators 9 configured to act on the circulation of the cleaning liquids or on respective physico-chemical magnitudes,
a control unit 24 configured to receive the signals from the physico-chemical sensors and to control the actuators, so as to maintain the physico-chemical magnitudes of the cleaning liquids at predetermined setpoint values.

The physico-chemical sensors 7 and the actuators 9 are located downstream of the equipment to be cleaned 102, in order to verify that the physico-chemical magnitude of the cleaning liquid exiting the equipment to be cleaned 102 is close to the setpoint value.

Furthermore, the storage vessel 2.2 is equipped with:
a main valve 3.11 which is intended to be fluidly connected to a non-represented water source, and
a secondary valve 3.12 which is intended to be fluidly connected to a concentrated solution source,

The control unit 24 is configured to control the openings and the closures of the main valve 3.11 and the secondary valve 3.12. When the main valve 3.11 is open, water is injected into the storage vessel 2.2. When the secondary valve 3.12 is open, the concentrated solution is injected into the storage vessel 2.2. The injections of water and the concentrated solution allow maintaining the concentration of the cleaning liquid at a predetermined setpoint value.

The control unit 24 is configured to control an automatic cleaning cycle including cleaning phases whose circulation durations and circulation flow rates of the cleaning liquids are predetermined.

When the cleaning installation 1 is in use, it may operate according to a cleaning method 1000 in accordance with the invention. FIG. 2 illustrates the cleaning method 1000 for cleaning equipment to be cleaned 102, herein containers. The cleaning method 1000 comprises an initial step comprising implementing the cleaning installation 1. Furthermore, the cleaning method 1000 comprises the steps:
1002) After stopping the production of the food products in the equipment 102, the control unit 24 firstly opens the transfer valve 4.11, then, successively, the distribution valves 6.11 and 6.21. The corresponding cleaning liquid circulates in the transfer conduit 10.1 in the transfer pipe 4.1, in the distribution module 4, and successively in the distribution pipes 6.1 and 6.2, then successively enters the equipment to be cleaned 102. The cleaning liquid exiting the equipment 102 is discharged from the cleaning installation 1 to an effluent collection 40.
1004) After a first predetermined duration, the control unit 24 closes the transfer valve 4.11. The control unit 24 opens the transfer valve 4.12, while one of the distribution valves 6.11 and 6.21 remains open. The corresponding cleaning liquid circulates in the transfer conduit 10.2, in the transfer pipe 4.2, in the distribution module 4, the distribution pipes 6.1 and 6.2, then successively enters the equipment to be cleaned 102. The cleaning liquid exiting the equipment 102 is discharged from the cleaning installation 1 to the effluent collection 40.
1006) After a second predetermined duration, the control unit 24 closes the transfer valve 4.12. The control unit 24 opens the transfer valve 4.13, while the distribution valves 6.11 and 6.21 remain open. The corresponding cleaning liquid circulates in the transfer conduit 10.3, in the transfer pipe 4.3, in the distribution module 4, the distribution pipes 6.1 and 6.2, then enters the equipment to be cleaned 102. The cleaning liquid exiting the equipment 102 is discharged from the cleaning installation 1.

The automatic cleaning cycle controlled by the control unit 24 may then end.

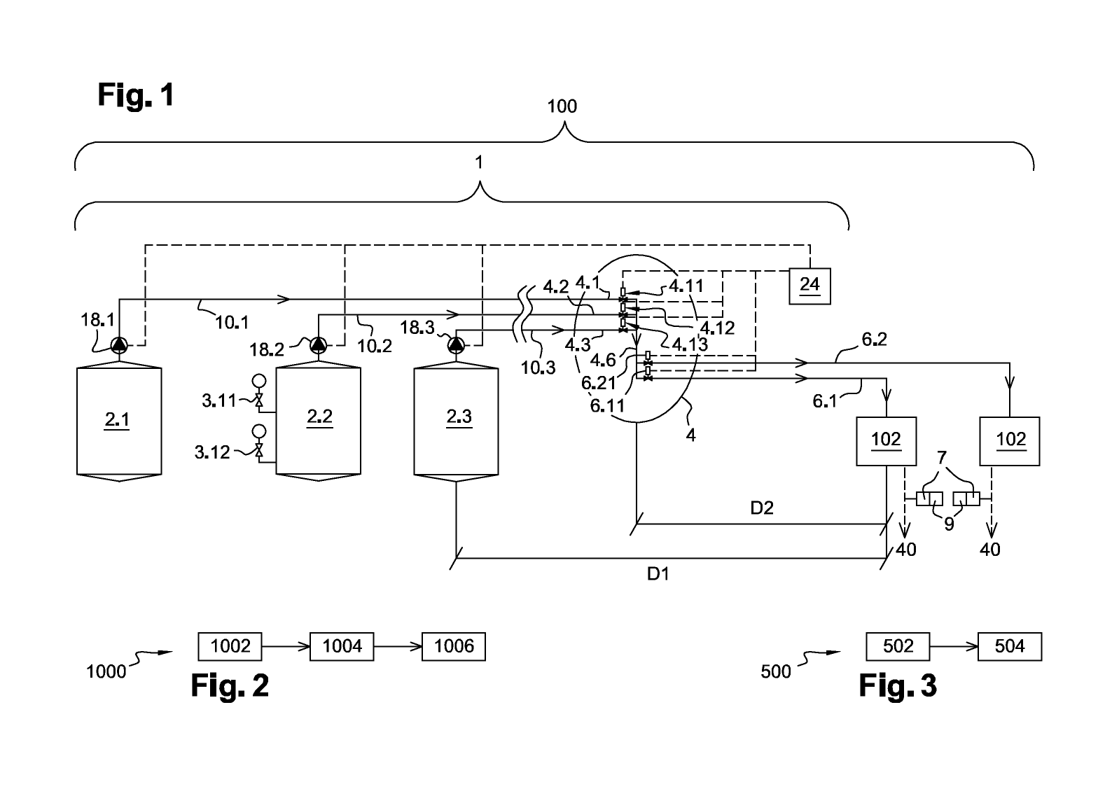

FIG. 3 illustrates a transformation process 500 in accordance with the invention for transforming a conventional cleaning installation intended to clean equipment to be cleaned 102, herein containers.

A conventional cleaning installation comprises
storage vessels 2.1, 2.2, 2.3, each configured to store a respective cleaning liquid, and
a non-represented supply line which is fluidly connected to each storage vessel 2.1, 2.2, 2.3, the supply line extending over a long length so as to conduct each cleaning liquid to at least one item of equipment to be cleaned 102.

The transformation process 500 comprises the steps including:
502) adding at least one distribution module 4 comprising at least one pipe configured to channel a cleaning liquid to at least one item of equipment to be cleaned 102, the at least one distribution module 4 being intended to be arranged near at least one item of equipment to be cleaned 102, and
504) replacing the supply line with several transfer conduits 10.1, 10.2, 10.3, each transfer conduit 10.1, 10.2, 10.3 being fluidly connected to a respective storage vessel 2.1, 2.2, 2.3, the at least one distribution module 4 being fluidly connected to several of the transfer conduits 10.1, 10.2, 10.3.

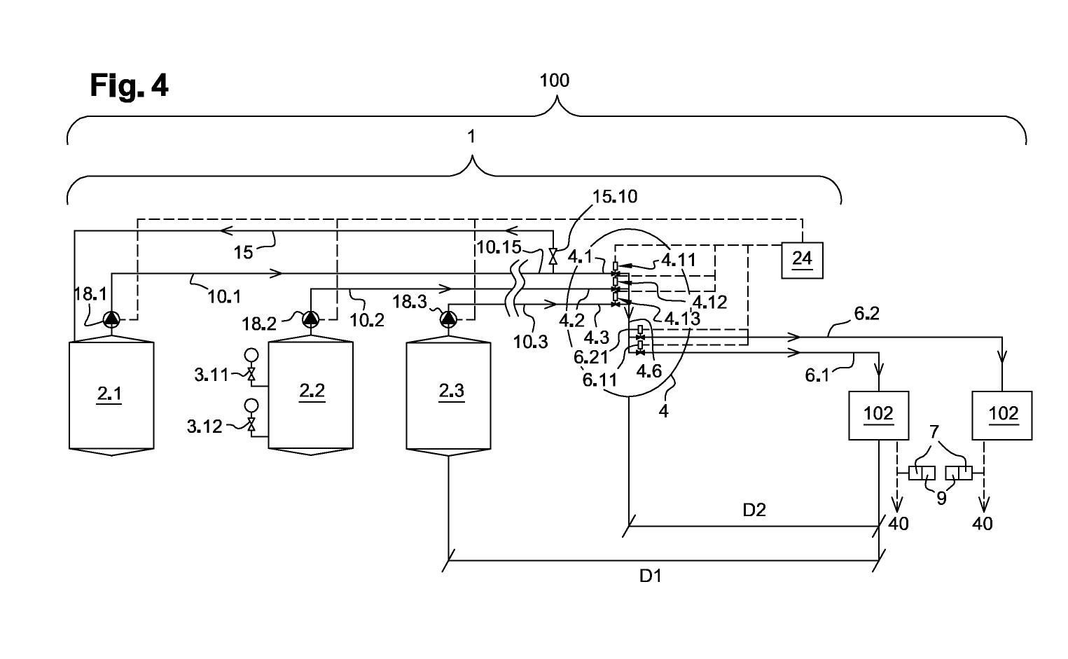

FIG. 4 illustrates a cleaning installation 1 in accordance with a second embodiment. To the extent that the cleaning installation 1 of FIG. 4 is similar to the cleaning installation 1 of FIG. 1, the description of the cleaning installation 1 given hereinabove relating to FIG. 1 may be transposed to the cleaning installation 1 of FIG. 4, excepting the significant differences mentioned hereinafter.

The cleaning installation 1 of FIG. 4 differs from the cleaning installation 1 of FIG. 1, because the cleaning installation 1 of FIG. 4 further comprises a loop conduit 15. The loop conduit 15 fluidly connects the storage vessel 2.1 to a downstream area 10.15 of the transfer conduit 10.1.

The downstream area 10.15 is located as close as possible to the distribution module 4. The cleaning installation 1 of FIG. 4 further comprises a loop valve 15.10 arranged on the loop conduit 15 in order to allow or prevent the circulation of cleaning liquid in the loop conduit 15.

FIG. 5 illustrates a cleaning installation 1 in accordance with a second embodiment. To the extent that the cleaning installation 1 of FIG. 5 is similar to the cleaning installation 1 of FIG. 1, the description of the cleaning installation 1 given hereinabove relating to FIG. 1 may be transposed to the cleaning installation 1 of FIG. 5, excepting the significant differences mentioned hereinafter.

The cleaning installation 1 of FIG. 5 differs from the cleaning installation 1 of FIG. 1, because the distribution module 4 of FIG. 5 comprises a heating module 11 including:
a tray 12 which is configured to contain a cleaning liquid,
a heating member 14 which is fluidly connected to the tray 12,
a distribution pump 16 which is connected to the tray 12 and to the heating member 14 so as to circulate a cleaning liquid from the tray 12 to the heating member 14.

When the cleaning installation 1 is in use, the tray 12 contains a cleaning liquid. The distribution pump 16 circulates a cleaning liquid from the tray 12 towards the heating member 14. The heating member 14 heats the cleaning liquid circulating therein which allows adjusting the temperature of this cleaning liquid.

Furthermore, the cleaning liquid exiting the equipment to be cleaned 102 may be reinjected into the tray 12, therefore into the heating member 14, when the control unit 24 opens a looping valve 4.102 belonging to the distribution module 4. Thus, the heating member 14 also heats this reinjected cleaning liquid, if needed.

Furthermore, the cleaning installation 1 of FIG. 5 differs from the cleaning installation 1 of FIG. 1, because the storage vessel 2.1 of FIG. 5 is equipped with:
a recirculation loop 20.1 arranged to fluidly connect two openings, namely an inlet and an outlet, of the storage vessel 2.1, and
a heating device 22.1 arranged to heat the cleaning liquid circulating in the recirculation loop 20.1.

When the cleaning installation 1 is in use, a cleaning liquid taken from the storage vessel 2.1 circulates in the recirculation loop 20.1. This cleaning liquid circulates in the heating device 22.1, where the cleaning liquid is heated, which allows adjusting the temperature of the storage liquid contained in the storage vessel 2.1.

Furthermore, the cleaning installation 1 of FIG. 5 differs from the cleaning installation 1 of FIG. 1, because the cleaning installation 1 of FIG. 5 further comprises three return conduits 30.1, 30.2 and 30.3 and three return valves 30.11, 30.21 and 30.31.

Each return conduit 30.1, 30.2 or 30.3 is fluidly connected to a respective storage vessel 2.1, 2.2 or 2.3. The distribution module 4 is fluidly connected to the three return conduits 2.1, 2.2 and 2.3. The control unit 24 is configured to drive (open and close) each return valve 30.11, 30.21 or 30.31 so as to allow or prevent the return of the cleaning liquids to the respective storage vessels 2.1, 2.2 and 2.3 respectively through the return conduits 30.1, 30.2 and 30.3.

Moreover, the control unit 24 may close the distribution valves 6.11 and 6.21, open the looping valve 4.102 and open one of the return valves 30.11, 30.21 and 30.31, for example the return valve 30.11. The cleaning liquid coming from the transfer conduit 4.1 enters the distribution module 4, circulates in the common section 4.6 and flows to the return line 30.11.

Thus each transfer conduit is connected to a respective return conduit so as to form a loop in which the cleaning liquid may permanently circulate as long as it does not flow towards the equipment to be cleaned 102. This permanent circulation of a cleaning liquid allows, if needed, mixing it (slurry) and/or reheating it. Furthermore, the liquid to be cleaned which permanently circulate is immediately available at the distribution module 4, since it is not necessary to move it in the corresponding transfer pipe 10.1, 10.2 or 10.3.

As for the cleaning installation 1 of FIG. 1, the control unit 24 of FIG. 2 is configured to control an automatic cleaning cycle including cleaning phases whose circulation durations and the circulation flow rates of the cleaning liquids are predetermined.

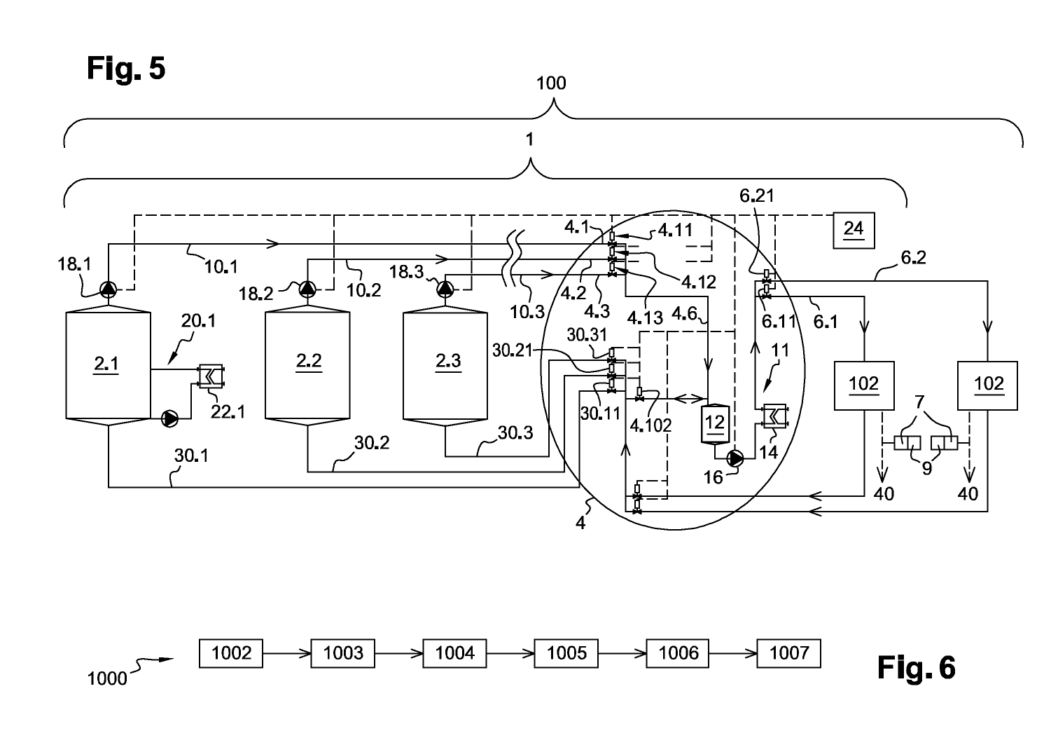

When the cleaning installation 1 is in use, it may operate according to a cleaning method 1000 which is illustrated in FIG. 6 and which is in accordance with a second embodiment. To the extent that a cleaning method 1000 of FIG. 6 is similar to a cleaning method 1000 of FIG. 2, the description of a cleaning method 1000 given above relating to FIG. 2 may be transposed to a cleaning method 1000 of FIG. 6, excepting the significant differences mentioned hereinafter.

As in the example of FIG. 2, the cleaning method 1000 of FIG. 6 comprises a step:
1002) After stopping the production of the food products in the equipment 102, the control unit 24 firstly opens the transfer valve 4.11, and, successively, the distribution valves 6.11 and 6.21. The corresponding cleaning liquid circulates in the transfer conduit 10.1, in the transfer pipe 4.1, in the distribution module 4, successively in the distribution pipes 6.1 and 6.2, then successively enters the equipment to be cleaned 102.
1003) Unlike the cleaning method 1000 of FIG. 2, where the cleaning liquid successively exiting the equipment 102 is discharged from the cleaning installation 1, in the cleaning method 1000 of FIG. 6, the control unit 24 opens the return valve 30.11, such that the cleaning liquid successively exiting the equipment 102 returns to the storage vessel 2.1.
1004) After a first predetermined duration, the control unit 24 closes the transfer valve 4.11. The control unit 24 opens the transfer valve 4.12, while one of the distribution valves 6.11 and 6.21 remains open. The corresponding cleaning liquid circulates in the transfer conduit 10.2, in the transfer pipe 4.2, in the distribution module 4, successively in the distribution pipes 6.1 and 6.2, then successively enters the equipment to be cleaned 102.
1005) Unlike the cleaning method 1000 of FIG. 2, where the cleaning liquid successively exiting the equipment 102 is discharged from the cleaning installation 1, in the cleaning method 1000 of FIG. 6, the control unit 24 opens the return valve 30.21, such that the cleaning liquid successively exiting the equipment 102 returns to the storage vessel 2.2.
1006) After a second predetermined duration, the control unit 24 closes the transfer valve 4.12. The control unit 24 opens the transfer valve 4.13, while one of the distribution valves 6.11 and 6.21 remains open. The corresponding cleaning liquid circulates in the transfer conduit 10.3, in the transfer pipe 4.3, in the distribution module 4, successively in the distribution pipes 6.1 and 6.2, then enters the equipment to be cleaned 102.
1007) Unlike the cleaning method 1000 of FIG. 2, where the cleaning liquid successively exiting the equipment 102 is discharged from the cleaning installation 1, in the cleaning method 1000 of FIG. 6, the control unit 24 opens the return valve 30.31, such that the cleaning liquid successively exiting the equipment 102 returns to the storage vessel 2.3.

The automatic cleaning cycle controlled by the control unit 24 may then end.

Of course, the present invention is not limited to the particular embodiments described in the present patent application, nor to embodiments within the scope of those skilled in the art. Other embodiments may be envisaged without departing from the scope of the invention, starting from any element equivalent to an element indicated in the present patent application. For example:
The cleaning installation may comprise several distribution modules which are arranged in the production plant respectively close to several groups of equipment to be cleaned distinct from each other. In this variant, each of the distribution modules comprises a respective distribution pipe, respective transfer pipes and respective transfer valves.

1. A cleaning installation (1), for cleaning equipment to be cleaned (102), for example containers, in a production plant (100), the cleaning installation (1) comprising several storage vessels (2.1, 2.2, 2.3) each configured to store a respective cleaning liquid;
the cleaning installation (1) being characterized in that it further comprises:
at least one distribution module (4) comprising at least one distribution pipe (6.1, 6.2) configured to channel a cleaning liquid to at least one item of equipment to be cleaned (102), the at least one distribution module (4) being intended to be arranged near at least one item of equipment to be cleaned (102), and
several transfer conduits (10.1, 10.2, 10.3), each transfer conduit (10.1, 10.2, 10.3) being fluidly connected to a respective storage vessel (2.1, 2.2, 2.3), the at least one distribution module (4) being fluidly connected to several of the transfer conduits (10.1, 10.2, 10.3).

2. The cleaning installation (1) according to the preceding claim 1, wherein at least one of the transfer conduits (10.1, 10.2, 10.3) extends from a respective storage vessel (2.1, 2.2, 2.3) to said at least one distribution module (4).

3. The cleaning installation (1) according to any one of the preceding claims, wherein the at least one distribution module (4) comprises a heating module (11) including:
a tray (12) configured to contain a cleaning liquid,
a heating member (14) fluidly connected to the tray (12),
a distribution pump (16) connected to the tray (12) and to the heating member (14) so as to circulate a cleaning liquid from the tray (12) to the heating member (14).

4. The cleaning installation (1) according to any one of the preceding claims, further comprising several transfer pumps (18.1, 18.2, 18.3) arranged such that each storage vessel (2.1, 2.2, 2.3) is fluidly connected to at least one transfer pump (18.1, 18.2, 18.3), each transfer pump (18.1, 18.2, 18.3) being fluidly connected to at least one transfer conduit (10.1, 10.2, 10.3).

5. The cleaning installation (1) according to any one of the preceding claims, wherein the at least one distribution module (4) comprises at least:
several transfer pipes (4.1, 4.2, 4.3), each transfer pipe (4.1, 4.2, 4.3) being fluidly connected to a respective transfer conduit (10.1, 10.2, 10.3), the transfer pipes (4.1, 4.2, 4.3) being fluidly connected to the distribution pipe (6.1, 6.2),
several transfer valves (4.11, 4.12, 4.13) arranged respectively on the transfer pipes (4.1, 4.2, 4.3), each transfer valve (4.11, 4.12, 4.13) being configured to be placed at least:
i) in a release configuration, in which a cleaning liquid may flow to the at least one distribution pipe (6.1, 6.2), and
ii) in a obstruction configuration.

6. The cleaning installation (1) according to any one of the preceding claims, wherein at least one of the storage vessels (2.1, 2.2, 2.3) is equipped with at least:
one recirculation loop (20.1) arranged for fluidly connecting two openings of said at least one storage vessel (2.1, 2.2, 2.3), and
one heating device (22.1) arranged for heating the cleaning liquid circulating in the recirculation loop (20.1).

7. The cleaning installation (1) according to any one of the preceding claims, further comprising at least one loop conduit (15), said at least one loop conduit (15) fluidly connecting a respective storage vessel (2.1, 2.2, 2.3) to a downstream area of a respective transfer conduit (10.1, 10.2, 10.3), the downstream area being located near or within the at least one distribution module (4).

8. The cleaning installation (1) according to any one of the preceding claims, further comprising several return conduits, each return conduit being fluidly connected to a respective storage vessel (2.1, 2.2, 2.3), the at least one distribution module (4) being fluidly connected to several of the return conduits.

9. The cleaning installation (1) according to any one of the preceding claims, further comprising a regulation device, the regulation device including:
physico-chemical sensors (7) each configured to generate signals representative of a respective physico-chemical magnitude,
actuators (9) configured to act on the circulation of the cleaning liquids or on respective physico-chemical magnitudes,
a control unit (24) configured to receive the signals from the physico-chemical sensors (7) and to control the actuators (9), so as to maintain the physico-chemical magnitudes of the cleaning liquids at predetermined setpoint values.

10. The cleaning installation (1) according to the preceding claim, wherein at least one storage vessel (2.1, 2.2, 2.3) is equipped with:
a main valve (3.11) intended to be fluidly connected to a water source, and
a secondary valve (3.12) intended to be fluidly connected to a concentrated solution source,
and wherein the control unit (24) is configured to control the openings and the closures of the main valve (3.11) and of the secondary valve (3.12) so as to inject the water and/or the concentrated solution into said at least one storage vessel (2.1, 2.2, 2.3) in order to maintain the concentration of the cleaning liquid at a predetermined setpoint value.

11. The cleaning installation (1) according to any one of the preceding claims, wherein the control unit (24) is configured to control an automatic cleaning cycle including cleaning phases whose circulation durations and circulation flow rates of the cleaning liquids are predetermined.

12. A transformation process method (500), for transforming a conventional cleaning installation intended to clean equipment to be cleaned (102), for example containers, the conventional cleaning installation comprising:
several storage vessels (2.1, 2.2, 2.3) each configured to store a respective cleaning liquid,
a supply line fluidly connected to each storage vessel (2.1, 2.2, 2.3), the supply line extending over a long length so as to conduct each cleaning liquid to at least one item of equipment to be cleaned (102);
the transforming process (500) comprising the steps consisting in:
502) adding at least one distribution module (4) comprising at least one pipe configured to channel a cleaning liquid to at least one item of equipment to be cleaned (102), the at least one distribution module (4) being intended to be arranged near at least one item of equipment to be cleaned (102), and
504) replacing the supply line with several transfer conduits (10.1, 10.2, 10.3), each transfer conduit (10.1, 10.2, 10.3) being fluidly connected to a respective storage vessel (2.1, 2.2, 2.3), the at least one distribution module (4) is fluidly connected to several of the transfer conduits (10.1, 10.2, 10.3).
